(19) United States
(12) Patent Application Publication
(10) Pub. No.: US 2010/0079343 A1
(43) Pub. Date: Apr. 1, 2010

(54) ANTENNA CONDUCTOR LAYOUT METHOD AND ANTENNA ARRAY FABRICATED THEREBY

(75) Inventors: CHENG-HSUAN HSU, Taipei County (TW); TSUNG-WEN CHIU, Taipei County (TW); WEN-HIS LEE, Taipei County (TW); Fu-Ren Hsiao, Taipei County (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/341,555

(22) Filed: Dec. 22, 2008

(30) Foreign Application Priority Data
Sep. 26, 2008 (TW) 097137186

(51) Int. Cl. H01Q 1/38; H01P 11/00

(52) U.S. Cl. 343/700 MS; 29/600

(57) ABSTRACT

The present invention discloses an antenna conductor layout method and an antenna array fabricated thereby. The antenna array of the present invention comprises a first conductor array having a plurality of first conductors arranged on a substrate to have a rectangular layout and a second conductor array having a plurality of second conductors also arranged on the substrate to have a rectangular layout. The first and second conductor arrays are arranged to form a symmetric antenna array, wherein the conductors are space-efficiently disposed without interfering with the radiation pattern, whereby designing the mechanism and installing the antenna becomes easier.

### BACKGROUND OF THE INVENTION

1. Field of the Invention

The present invention relates to an antenna conductor layout method and an antenna array fabricated thereby, particularly to a symmetric antenna conductor layout and an antenna array using the same conductor layout.

2. Description of the Related Art

Wireless communication has begun to adopt antenna arrays, especially the new-generation Wi-Fi communication, wherein the designers further apply the Multiple-Input Multiple-Output (MIMO) technology or the IEEE.802.11n (also called Draft-n) technology to the existing IEEE.802.11g wireless transceiver. The past Wi-Fi communication device uses only one set of antenna. However, the MIMO technology and the Draft-n technology have to use at least two sets of antennae, i.e. the so-called antenna array.

In addition to Wi-Fi, other wireless communication systems, such as WiMAX and 3G, are also panning to incorporate the antenna array into their developments. Even we may say the antenna array is an indispensable technology to promote the wireless receiving and transmitting efficiency in addition to the Orthogonal Frequency-Division Multiplexing (OFDM) technology.

Conventionally, improving the wireless receiving and transmitting efficiency is realized by increasing the radiation conductors. Referring to FIG. 1, a top view of a conductor structure of a conventional 3×3 antenna array is shown, wherein the conductors 12 are separated by a specified spacing and arrayed orderly. Signal cables connect the conductors 12 and form a feeder network 13. Signals are fed into the feeder network 13 via a feeder point 14 and transferred to the conductors 12 and then transmitted therefrom.

However, the conventional conductor structure is not fully symmetric. To enable all conductors to have an identical power and phase, the widths, lengths, and paths of the signal cables of the feeder network 13 must be elaborately designed. Thus, as the complexity of the conductor structure increases, the radiation pattern thereof is affected. Besides, holes are usually formed in the perimeter of the substrate 11, and screws are driven through the holes to fix the substrate 11 to the device, wherein the holes should not interfere with the installation of the conductors. Thus is increased the difficulty of design, inconvenienced the assemblage, and lowered the yield of production.

### SUMMARY OF THE INVENTION

One objective of the present invention is to provide an antenna conductor layout method, wherein the antenna array comprises a first conductor array having a plurality of first conductors arranged to form the first rectangle and the second conductor array having a plurality of second conductors arranged to form the second rectangle, and wherein the first conductors and the second conductors are moved or rotated to appropriate positions with the intersection of the first and second axes of the first and second rectangles being the center, whereby the present invention has a higher flexibility of the conductor layout and may vary the conductor layout to meet the structure of the product.

Another objective of the present invention is to provide an antenna conductor layout method, wherein the first conductor array and the second conductor array are arranged to form a symmetric antenna array to achieve a better radiation pattern, and wherein the conductors are space-efficiently disposed to increase the convenience of installation in various wireless communication devices.

A further objective of the present invention is to provide an antenna array, which has a symmetric conductor layout and a feeder network with a symmetric signal transmission path, whereby the antenna array has a better radiation pattern and a simplified feeder network, wherefore the fabrication difficulty is decreased and the production yield is increased.

To achieve the abovementioned objectives, the present invention proposes an antenna conductor layout method and an antenna array fabricated thereby. The antenna array of the present invention comprises the first conductor array and the second conductor array. In the first conductor array, a plurality of conductors is arranged to form a rectangular layout. The centers of all the first conductors are connected to form the first rectangle, and the diagonals of the first rectangle are defined to be the first axes. In the second conductor array, a plurality of second conductors is also arranged to form a rectangular layout. The centers of all the second conductors are connected to form a second rectangle, and the diagonals of the second rectangle are defined to be the second axes. The first axes and the second axes intersect to contain an angle of 40-50 degrees therebetween. The first and the second conductor arrays are arranged to form a symmetric antenna array, wherein the conductors are space-efficiently disposed without interfering with the radiation pattern, whereby designing the mechanism and installing the antenna becomes easier.

The present invention features the symmetry of the first conductor array and the second conductor array. In the first conductor array, two conductors are arranged oppositely to each other, and the spacing therebetween is appropriately controlled to achieve the best gain. In the second conductor array, the second conductors are also arranged oppositely to each other, and the spacing therebetween is also appropriately controlled to achieve the best gain. Further, the feeder network contains a plurality of symmetrically arranged metal cables having identical size, whereby the antenna array has a superior radiation pattern. Furthermore, the present invention arranges the conductors appropriately and space-efficiently to prevent the installation holes and screws from overlapping the conductors and to simplify the conductor structure, whereby the difficulty of mechanism design is decreased, and the antenna array can be easily assembled to various wireless communication devices.

### BRIEF DESCRIPTION OF THE DRAWINGS

FIG. 1 is a top view of a conductor structure of a conventional 3×3 antenna array;

FIG. 2 is a top view of an antenna array according to a first embodiment of the present invention;

FIG. 3 is a top view of an antenna array according to a second embodiment of the present invention;

FIG. 4 is a diagram showing the measurement results of the radiation pattern of an antenna array according to the present invention; and

FIG. 5 is a partially-enlarged view schematically showing that an antenna array is integrated with a wireless communication device according to a third embodiment of the present invention.

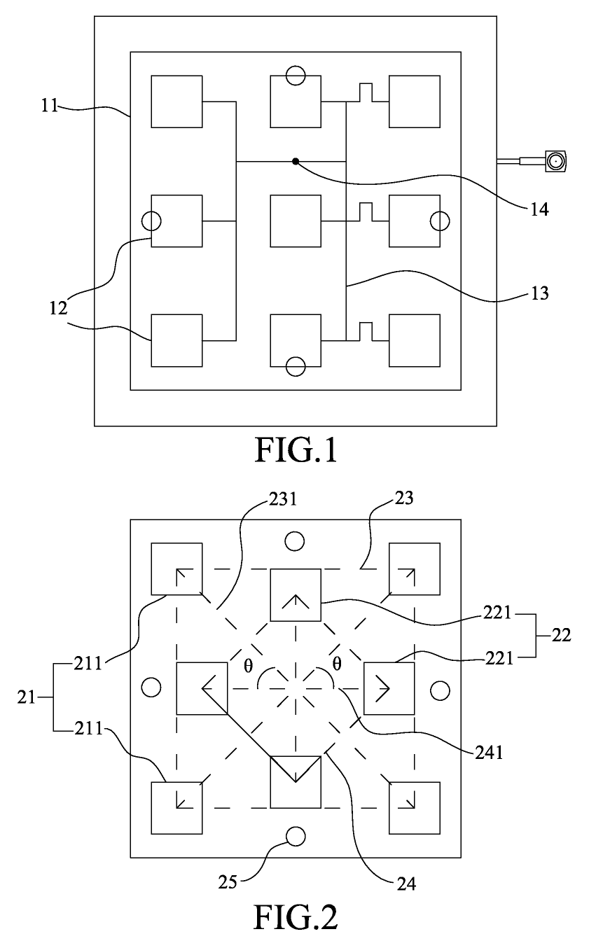

### DETAILED DESCRIPTION OF THE INVENTION

Below, the technical contents are described in detail with the embodiments. However, it should be understood that the embodiments are only to exemplify the present invention but not to limit the scope of the present invention.

Referring to FIG. 2, a top view of an antenna array according to the first embodiment of the present invention is shown. The antenna array of the present invention comprises the first conductor array 21 and the second conductor array 22. In the first conductor array 21, a plurality of first conductors 211 are arranged to form a rectangular layout, and the centers of all the first conductors 211 are connected to form a first rectangle 23. In the embodiment of FIG. 2, four pieces of first conductors 211 are used to form the first conductor array 21. The diagonals of the first rectangle 23 are defined to be first axes 231. In the second conductor array 22, a plurality of second conductors 221 is also arranged to form a rectangular layout, and the centers of all the second conductors 221 are connected to form a second rectangle 24. In the embodiment shown in FIG. 2, four pieces of second conductors 221 are used to form the second conductor array 22. The diagonals of the second rectangle 24 are defined to be second axes 241.

The two diagonals of the first rectangle 23 form two first axes 231 cross to each other. The two diagonals of the second rectangle 24 form two second axes 241 cross to each other. The first axes 231 and the second axes 241 intersect at the center to form an intersection and contain an angle of 40-50 degrees.

In this embodiment, the first and second conductor arrays 21 and 22 respectively contain four pieces of first conductors 211 and four pieces of second conductors 221. All the conductors have identical dimensions with a length of about 30 mm and a width of about 30 mm.

In this embodiment, the symmetric first conductor array 21 and second conductor array 22 are combined to form an assembly antenna array. In this embodiment, each two first conductors 211 are arranged oppositely to each other, and each two second conductors 221 are also arranged oppositely to each other. All the conductors are arranged space-efficiently and away from installation holes 25, whereby the mechanism design becomes easier, and the antenna system has a better radiation pattern.

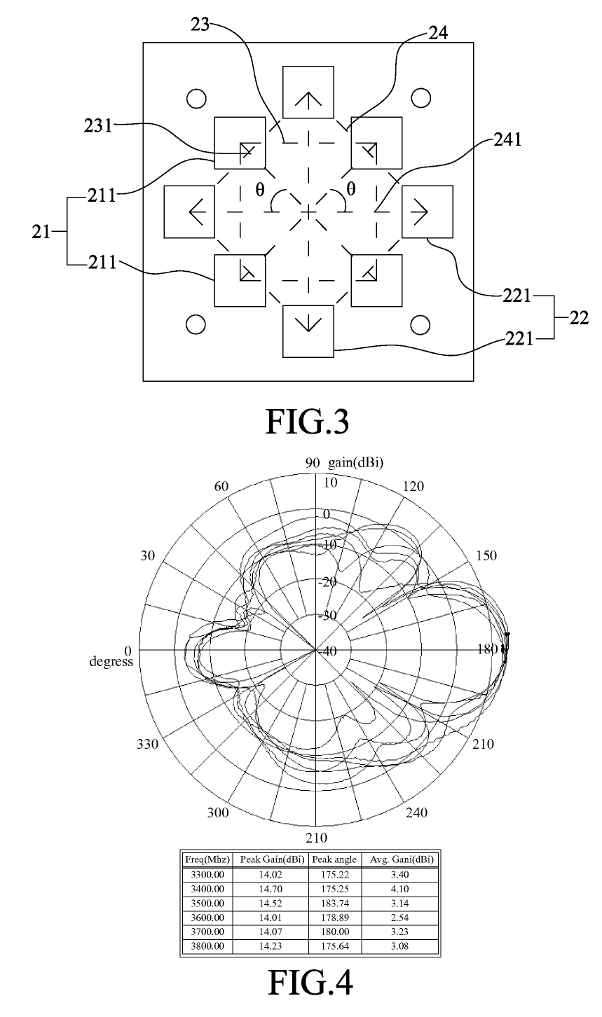

Referring to FIG. 3, a top view of an antenna array according to a second embodiment of the present invention is shown. In this embodiment, the first conductors 211 of the first conductor array 21 are moved inward from the perimeter, and the second conductors 221 of the second conductor array 22 are moved outward from the interior. In this embodiment, the first conductors 211 are arranged to form a rectangular layout, and the second conductors 221 are also arranged to form a rectangular layout. The diagonals of the first and second conductor arrays 21 and 22 are also defined to be the first and second axes 231 and 241.

No matter where the installation holes 25 and the screws are arranged, the conductors can always be appropriately disposed according to the principle demonstrated by the embodiments described above, whereby designing the mechanism and controlling the radiation pattern becomes easier.

Referring to FIG. 4, a diagram shows the measurement results of the radiation pattern of the antenna array according to the present invention, wherein the central frequency of the antenna array is defined to be between 3300 and 3800 MHz, and each curve represents the radiation pattern of a specified central frequency. The radiation patterns have an average peak gain of as high as 14 dBi, which shows that the present invention can indeed achieve a high gain and that the present invention can achieve an intended radiation pattern more easily.

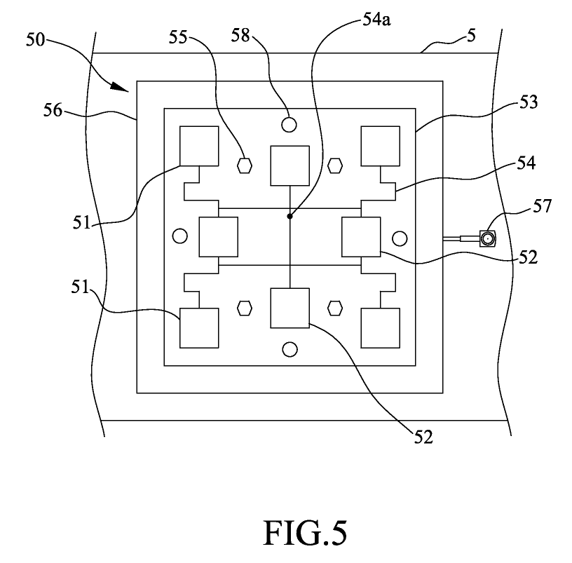

Referring to FIG. 5, a partially-enlarged view schematically shows that an antenna array is integrated with a wireless communication device according to a third embodiment of the present invention. In this embodiment, an antenna array 50 is installed in a wireless communication device 5, and the first conductor array 51 and the second conductor array 52 are arranged on a substrate 53. A plurality of metal cables are arranged symmetrically to form a feeder network 54, and feeder network 54 connects the first conductor array 51 and the second conductor array 52. The feeder network 54 has a feeder point 54a arranged near the intersection of the first axes of the first conductor array 51 and the second axes of the second conductor array 52. A plurality of support elements 55 is distributed on the substrate 53 and used to support the substrate 53. A ground plane 56 carries the support elements 55. Additionally, a feeder cable 57 has a central wire connected to the feeder point 54a and an external wire connected to the ground plane 56.

In this embodiment, each two conductors are arranged oppositely to each other to form the first and second conductor arrays 51 and 52, whereby the present invention can effectively achieve an intended radiation pattern and a high antenna gain, and whereby the conductors can always be appropriately disposed to avoid overlapping the installation holes 58, wherefore designing the mechanism and installing the antenna becomes easier.

The above description shows that the present invention indeed possesses utility, novelty and non-obviousness and meets the condition for a patent. The embodiments described above are only to exemplify the present invention but not to limit the scope of the present invention. Any equivalent modification or variation according to the spirit of the present invention is to be also included within the scope of the present invention.

What is claimed is:

1. An antenna conductor layout method comprises steps:
arranging a plurality of first conductors to form a first conductor array having a rectangular layout, connecting centers of all said first conductors to form a first rectangle, defining diagonals of said first rectangle to be first axes; and
arranging a plurality of second conductors to form a second conductor array having a rectangular layout, connecting centers of all said second conductors to form a second rectangle, defining diagonals of said second rectangle to be second axes, wherein said first axis and said second axis contain an angle of between 40 and 50 degrees.

2. The antenna conductor layout method according to claim 1, wherein said diagonals of said first rectangle form two first axes.

3. The antenna conductor layout method according to claim 1, wherein said diagonals of said second rectangle form two second axes.

4. The antenna conductor layout method according to claim 1, wherein said first axes and said second axes intersect to form an intersection.

5. An antenna array comprising
a substrate;
a first conductor array having a plurality of first conductors arranged on said substrate to have a rectangular layout, wherein centers of all said first conductors are connected to form a first rectangle, and diagonals of said first rectangle are defined to be first axes;
a second conductor array having a plurality of second conductors arranged on said substrate to have a rectangular layout, wherein centers of all said second conductors are connected to form a second rectangle, and diagonals of said second rectangle are defined to be second axes, wherein said first axis and said second axis contain an angle of between 40 and 50 degrees;
a feeder network having a plurality of metal cables and a feeder point and connecting said first conductor array and said second conductor array;
support elements supporting said substrate; and
a ground plane carrying said support elements.

6. The antenna array according to claim 5 further comprising a feeder cable having
a central wire connected to said feeder point; and
an external wire connected to said ground plane.

7. The antenna array according to claim 5, wherein said diagonals of said first rectangle form two first axes.

8. The antenna array according to claim 5, wherein said diagonals of said second rectangle form two second axes.

9. The antenna array according to claim 5, wherein said first axes and said second axes intersect to form an intersection.

10. The antenna array according to claim 5, wherein said intersection of said first axes and said second axes is near said feeder point.

11. The antenna array according to claim 5, wherein said feeder network has a symmetric layout.
